(19) United States
(12) Patent Application Publication
(10) Pub. No.: US 2011/0295408 A1
(43) Pub. Date: Dec. 1, 2011

(54) PROCESS FOR POSITIONING A WORKPIECE

(75) Inventors: Max Christopher Burgel, White Lake, MI (US); Brian R. Dickinson, Grass Lake, MI (US)

(73) Assignee: Toyota Motor Engineering & Manufacturing North America, Inc., Erlanger, KY (US)

(21) Appl. No.: 12/789,210

(22) Filed: May 27, 2010

(51) Int. Cl. G05B 19/19

(52) U.S. Cl. 700/114; 700/192; 700/186; 700/194

(57) ABSTRACT

A process for accurately determining a workpiece position in relation to a reference coordinate system is provided. The process includes providing a machine having a table and a machine coordinate system, determining locations of three reference geometric aspects of the table, providing a workpiece, and attaching the workpiece to the table. Thereafter, locations of three geometrical aspects of the workpiece are determined using photogrammetry followed by calculation of any offset between the three reference geometrical aspects of the table and the three geometrical aspects of the workpiece. Any offset that has been determined can then be used to accurately determine the workpiece position in relation to the reference coordinate system.

### FIELD OF THE INVENTION

The present invention relates to a process for locating a workpiece, and in particular, a process for locating a workpiece within the work envelope of a machine tool or fixture using photogrammetry.

### BACKGROUND OF THE INVENTION

Machining is known as a collection of material-working processes in which a power-driven machine uses cutting tools, abrasives or electrodes to mechanically cut and remove material from a workpiece in order to achieve a desired geometry for a component. In most instances, the workpiece is attached to a workbench, table, vise, etc. that is part of a machining apparatus before it is “machined”. Such material-working or “machining” processes are known to those skilled in the art as drilling, milling, turning and the like. In addition, machining is typically included during the manufacture of most metallic products and can be used when making components made from other materials such as wood, plastic, etc.

Most modern-day machining equipment uses computer numerical control (CNC) for laying out and/or controlling a tool path. In some instances, computer-aided design (CAD) data of the workpiece and/or a finished, or partially finished, component can be used to pre-program the tool path.

Locating the position of the workpiece on the machining equipment can be performed by mechanically determining or “picking out” known features of the workpiece after it has been attached to the workbench, table, etc. In some instances, tooling balls (spheres), holes in the workpiece, edges on the workpiece, and the like can be used as the known features with a test indicator or a tactile probe placed in a spindle of the machining apparatus used to determine the location of the known features relative to a coordinate system of the apparatus. In some instances, the positions of three known features on the workpiece can be determined and CAD data, or in the case of CNC machine tools, a tool path code, can be translated to correspond to the positions of the known features. However, heretofore processes for determining the positions of the known features on the workpiece can take considerable time, man-hours, etc. Therefore, an improved process for accurately determining the position of the workpiece within a work envelope of a machining apparatus, testing fixture, fabrication fixture, and the like would be desirable.

### SUMMARY OF THE INVENTION

A process for accurately determining a workpiece position and/or orientation in relation to a machine coordinate system is provided. The process includes providing a machining apparatus, testing fixture, fabrication fixture, and the like having a table or work envelope and a reference coordinate system, determining locations of three reference geometric aspects of the table, providing a workpiece, and attaching the workpiece to the table. Thereafter, locations of three geometrical aspects of the workpiece can be determined using photogrammetry with an offset between the three reference geometrical aspects of the table and the three geometrical aspects of the workpiece used to accurately determine the workpiece position and/or orientation in relation to the reference coordinate system.

In some instances, the three reference geometrical aspects of the table are three points, while in other instances the three reference geometrical aspects are one plane and two axes. In still other instances, the three reference geometrical aspects are one plane, one axis, and one point. In addition, the three reference geometrical aspects of the workpiece can be three contrast targets that are attached thereto.

The machine can have a tool with a tool path, the tool path being a function of, related to and/or referenced to the reference coordinate system. In addition, the tool path can be adjusted by the offset between the three reference geometrical aspects of the table and the three geometrical aspects of the workpiece. In this manner, the position of the workpiece within a work envelope of the machine can be determined in a time and cost effective manner.

The process can further include machining a first portion of the workpiece using a first cutting tool and a first tool path—sometimes referred to as a first operation and/or first set-up—followed by moving the workpiece into a different position and/or orientation and machining a second portion of the workpiece using a second cutting tool and a second tool path. In some instances, the first cutting tool and the second cutting tool are the same tool. In addition, an offset between the three reference geometrical aspects of the table and three geometrical aspects of the workpiece after it has been moved can be used to adjust the second tool path and thereby account for the different position of the workpiece. It is appreciated that machining the first portion and the second portion of the workpiece can provide a finished component. In some instances, the finished component can be an organic-shaped component.

The process for accurately determining the workpiece position in relation to the machine coordinate system can include machining of the workpiece in which computer-aided design (CAD) data related to the workpiece is provided and used to establish a pre-determined tool path. The tool path can be established or determined using CAD data that has been translated, rotated and/or adjusted by the offset between the three reference geometrical aspects of the table and three geometrical aspects of the workpiece.

### BRIEF DESCRIPTION OF THE DRAWINGS

FIG. 1 is a perspective view of an embodiment of the present invention illustrating the use of photogrammetry to determine a position of a workpiece on a table of a machining system;

FIG. 2 is a perspective view of another embodiment of the present invention illustrating the use of photogrammetry to determine a position of a workpiece on a table of a machining system;

FIG. 3 is a perspective view of yet another embodiment of the present invention illustrating the use of photogrammetry to determine a position of a workpiece on a table of a machining system;

FIG. 4 is an enlarged view of a workpiece labeled FIG. 4 in FIG. 1;

FIG. 5 is a perspective view of the machining system in FIG. 1 machining a first portion of the workpiece shown in FIG. 4;

FIG. 6 is a perspective view of the workpiece located at a different position on the table of the machining system;

FIG. 7A is a schematic representation of the workpiece shown in FIG. 1 located in a first position;

FIG. 7B is a schematic representation of the workpiece shown in FIG. 3 located in a second position;

FIG. 8 is a schematic representation of the reference coordinate system and possible offsets applied thereto; and

FIG. 9 is a schematic representation of an original CAD data orientation having been translated to a new CAD data orientation.

### DETAILED DESCRIPTION OF THE INVENTION

The present invention provides a process for accurately determining a workpiece position, location and/or orientation in relation to a reference coordinate system for a machining apparatus, testing fixture, fabrication fixture and the like using photogrammetry. For purposes of the present invention, the terms position and location are used interchangeably. The photogrammetry can be used to determine an offset between the position of the workpiece within a work envelope and the reference coordinate system and the offset can be used to alter a tool path of a tool that will remove material from the workpiece. In this manner, setup time for a machining process can be reduced and the present invention has utility as a process for machining a component, reducing the overall time required to machine the component, etc.

It is appreciated that photogrammetry involves the use of optics and projective geometry to determine geometric properties of objects from photographic images. Modern photogrammetry, sometimes referred to as stereophotogrammetry, includes estimating three-dimensional (3D) coordinates of one or more points on an object. The coordinates are determined by measurements made in a series of photographic images taken from different angles or positions, with common points identified on each image and a line of sight or ray constructed from a camera location to the points on the object. Triangulation, i.e. the intersection of the rays can then be used to determine the three-dimensional location of the point.

The inventive process includes determining a first position and/or orientation of the workpiece within the work envelope of a machining apparatus, testing fixture, fabrication fixture and the like using photogrammetry, and in some instances, determining a second position and/or orientation of the workpiece within the work envelope using photogrammetry after it has been moved from the first position. A table can be included as part of the machining apparatus, testing fixture, fabrication fixture and the like, and the workpiece can be attached to the table when it is in the first position and/or the second position. Any offset between the workpiece position and the reference coordinate system can be accurately and quickly determined using the photogrammetry and supplied to a computer aided machining system.

In order to determine a position, orientation and/or offset of the workpiece, photogrammetry can be used to locate at least three reference geometrical aspects of the table and at least three geometrical aspects of the workpiece when it is in the first position and/or the second position. The three reference geometrical aspects of the table can be tooling balls (spheres), holes in the table, edges, and the like, and the three geometrical aspects of the workpiece can be contrast targets. In addition, the three reference geometrical aspects of the table can be three points, one plane and two axes or one plane, one axis, and one point.

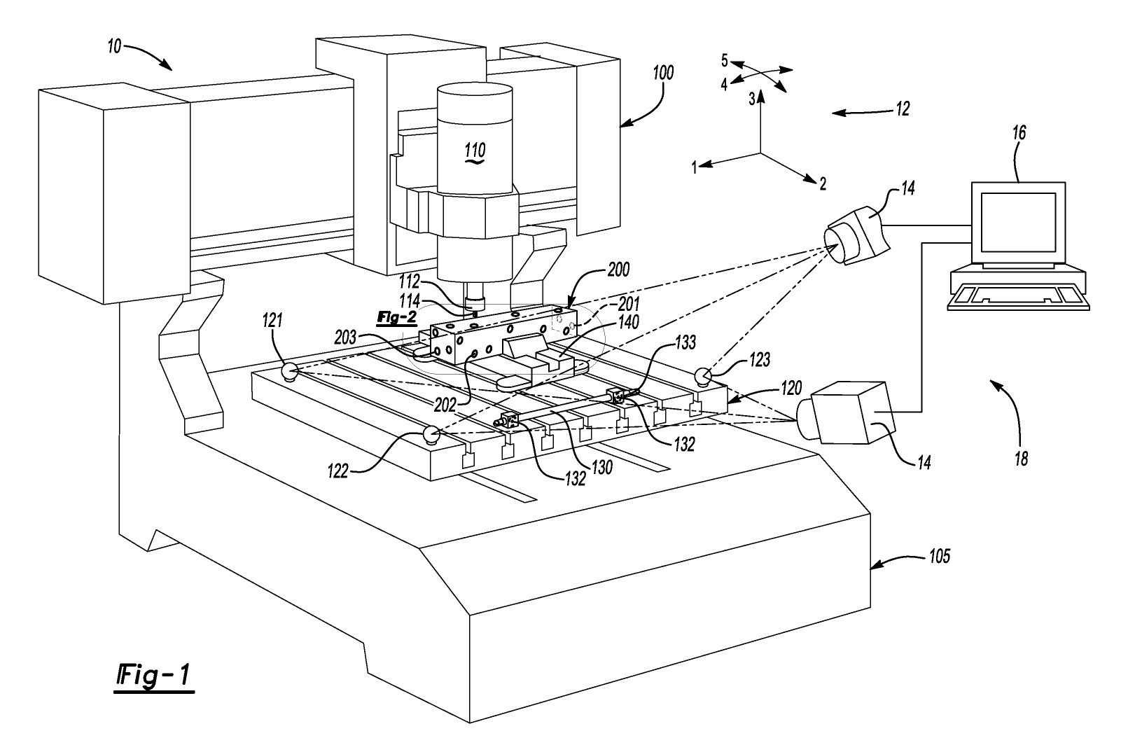

Turning now to the figures, FIG. 1 provides a perspective view of a machining system 10 that has a column 100, a base 105, a tool motor 110, and a table 120. The tool motor 110 can include a tool or machine spindle 112 that can firmly hold a cutting tool 114 and a workpiece 200 can be provided and be attached to the table 120 using a vise 140.

The machining system 10 can have several degrees of freedom, illustratively shown for example purposes only as five degrees of freedom at reference numeral 12. It is appreciated that the five degrees of freedom include movement along three orthogonal axes labeled 1, 2, 3, and tilting or rotation in a direction parallel to a plane defined by the axes 1 and 3, and tilting or rotation in a direction parallel to a plane defined by axes 2 and 3. For the purposes of the present invention, the axes 1, 2 and 3 are hereafter also referred to as a machine or reference coordinate system 12.

In addition to the machining system 10, a digital camera 14 in communication with a computer 16 having desirable software can afford for a photogrammetry system 18 and thus photogrammetry of the workpiece 200. In some instances, the table 120 can have at least three reference geometric aspects 121, 122, 123 whose location is known in relation to the reference or machine coordinate system 12. In some instances, spheres, tooling balls, etc., can be used as the three reference geometric aspects 121, 122, 123, and in combination with a surface scanning system, can afford for the definition of the top surface of the table 120 as a plane and the location of the table 120 relative to the machine coordinate system 12.

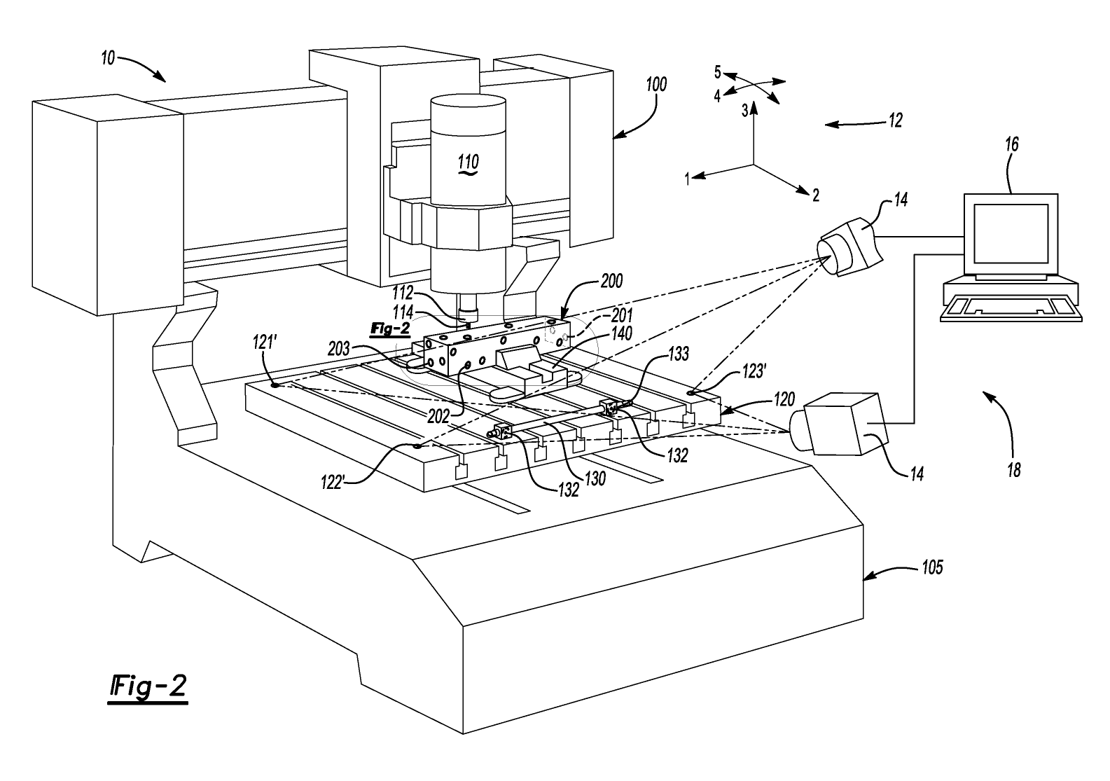

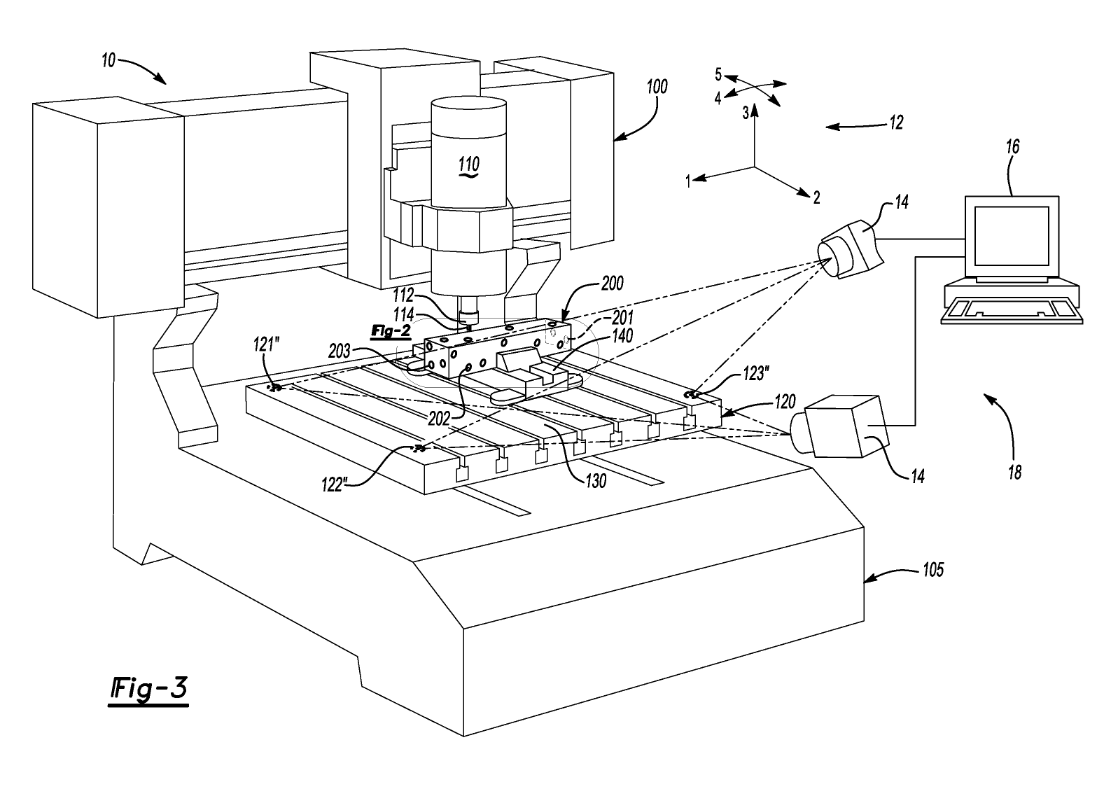

In the alternative, contrast targets such as those illustrated at 121□, 122□, 123□ in FIG. 2 can be used as the three reference geometric aspects, and in combination with a gauge bar 130 having coded contrast targets 132 and a photogrammetry or optical digitizing system, can afford for the definition of the top surface of the table 120 as a plane and the location of the table 120 relative to the machine coordinate system 12. In yet another alternative, three coded contrast targets such as those illustrated at 121□□, 122□□, 123□□ in FIG. 3 can be used as the three reference geometric aspects, and in combination with photogrammetry or optical digitizing, can afford for the definition of the top surface of the table 120 as a plane and the location of the table 120 relative to the machine coordinate system 12 without the use of the gauge bar 130.

The workpiece 200 can have at least three geometric aspects which may or may not be identifiable through the use of contrast targets. For example and for illustrative purposes only, contrast targets 201, 202, 203 shown in FIG. 1 can be used with photogrammetry or optical digitizing to determine the position of the workpiece 200 with respect to the machine tool's coordinate system 12. Stated differently, surface scanning and/optical digitizing of the three geometric aspects 121, 122, 123 and the three geometric aspects 201, 202, 203 using the camera 14 from at least three different angles can provide the position of the workpiece 200 relative to the geometric aspects 121, 122, 123.

In some instances, the machining system 10 can have one or more tool paths for the tool 114, the one or more tool paths affording for material removal from the workpiece 200 in order to produce a finished component. In the event that the position of the workpiece 200 is offset from the machine coordinate system 12, the determination of the position of the workpiece 200 using photogrammetry affords for the machining system 10 to alter the tool path as a function of the offset. As a result, time that has heretofor been required to accurately position the workpiece 200 relative to the table 120 can be eliminated by simply determining the position of the workpiece 200 relative to the table 120 using photogrammetry and subsequently altering the tool path by the measured offset between the position of the workpiece 200 and the reference coordinate system 12.

It is appreciated that the inventive process can also be used to determine the location of holding fixtures or pallets. For example and for illustrative purposes only, the process can be used to determine the location(s) of dedicated tooling used periodically to hold a part, component, etc or a group of parts, components, etc. In the alternative, the process can greatly facilitate the ability of a user to use one fixture in multiple machines rather than making a dedicated fixture for each specific machine.

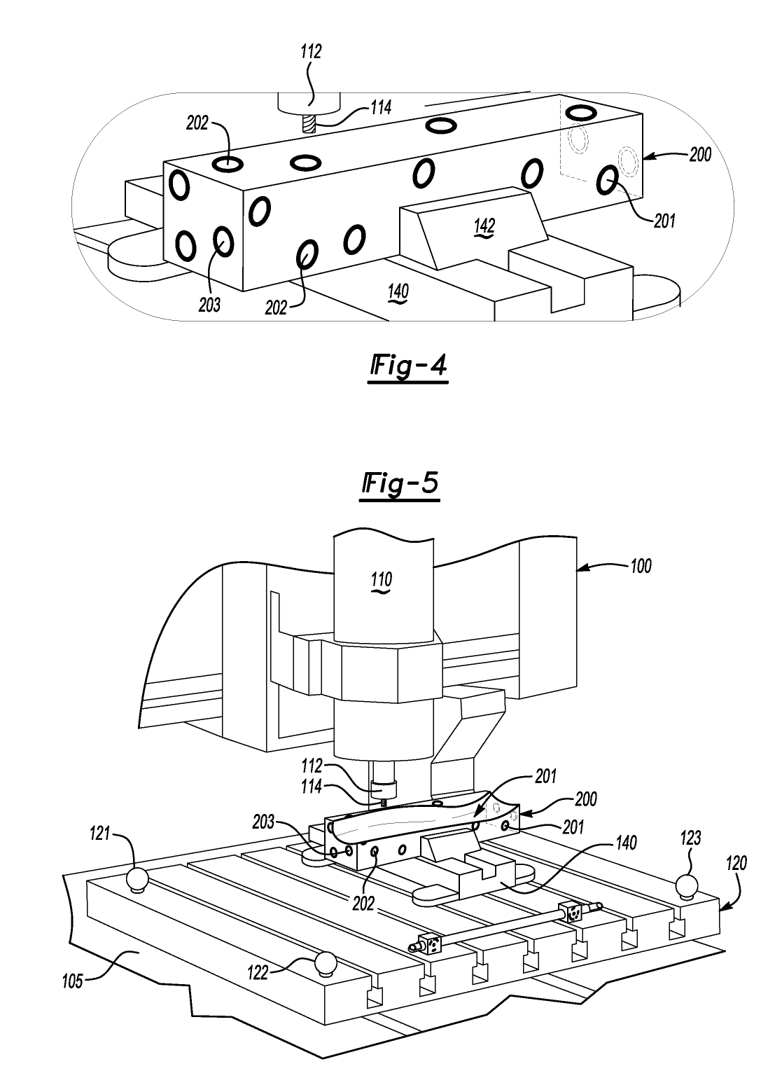

Turning now to FIG. 4, an enlarged view of the workpiece 200 in FIGS. 1-3 is shown, the workpiece 200 having a plurality of contrast targets thereon. For example and for illustrative purposes only, the three contrast targets labeled 201, 202, 203 are shown and can be used by a photogrammetry system to determine the position of the workpiece 200 relative to the three geometric aspects 121, 122, 123 and thus reference coordinate system 12. It is appreciated that the workpiece 200 can be attached to the table 120 using the vise 140, the vise 140 having one or more vise jaws 142 that can exert force on the workpiece 200 as known to those skilled in the art.

Referring now to FIG. 5, a first portion 210 has been removed from the workpiece 200 as part of a machining process to produce a final component. As shown in the figure, the remaining workpiece 200 has a contoured surface and contrast targets 201, 202, 203 still attached thereto.

Referring now to FIG. 6, in some instances, after a first portion 210 has been removed from the workpiece 200, the workpiece can be moved. For example and for illustrative purposes only, and assuming that the workpiece 200 is in a first position in FIG. 5, the workpiece 200 can be flipped, rotated, etc. to a second position as illustrated in FIG. 6 such that a second portion of the workpiece 200 can be machined away and/or removed therefrom. In addition, workpiece 200 can be turned, flipped, etc. such that an unmachined portion of the workpiece is located proximate to the tool 114 and additional machining can occur.

It is appreciated that although FIG. 6 illustrates the vise 140 clamping onto a planar surface of the workpiece 200, in some instances, the workpiece 200 can be attached to the table 120 by clamping of a nonplanar portion of the workpiece using the vise 140. In such instances, accurate alignment of the workpiece 200 relative to the table 120 and thus the machine coordinate system 12 using traditional methods can be extremely time inefficient if not impossible. However, using the inventive process described herein, the location of the workpiece 200 relative to the reference coordinate system 12 can be quickly and easily determined. In some instances, computer-aided design (CAD) data for a finished component can be altered, translated, offset, etc. to reflect the new position of the workpiece 200 and thereby used to provide a revised tool path.

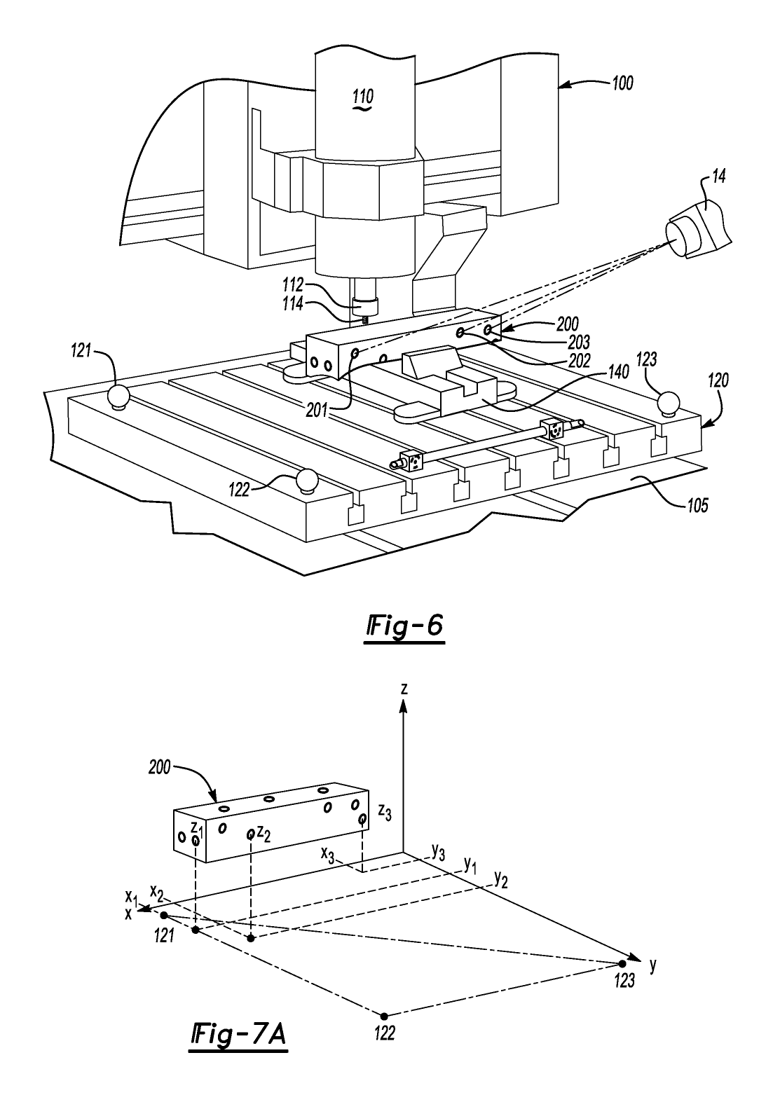

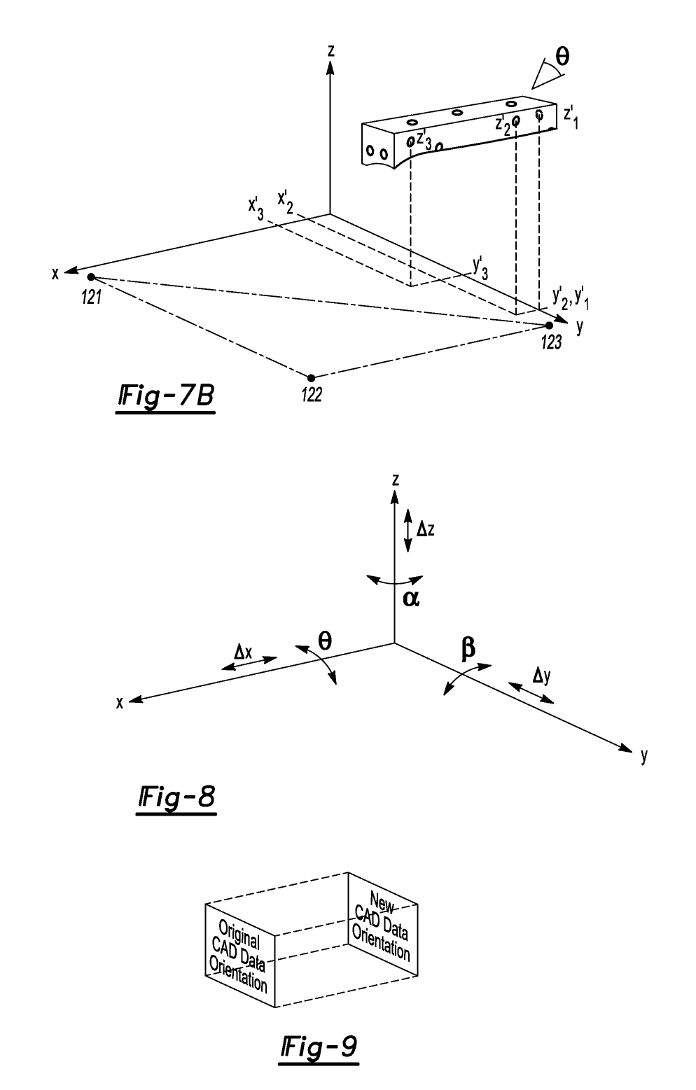

For example, FIGS. 7A and 7B illustrate the workpiece 200 being located at a first position (FIG. 7A) relative to the reference geometric aspects 121, 122, 123 with the three reference geometric aspects 201, 202, 203 of the workpiece 200 each having coordinates (e.g. x₁, y₁, z₁) that afford for an accurate position of the workpiece to be determined relative to the reference coordinate system 12. Once the workpiece has been moved into a second position (FIG. 7B), the three geometric aspects 201, 202, 203 can be optically digitized using camera 14 and with photogrammetry techniques afford for the determination of another set of coordinates (e.g. x′₁, y′₁, z′₁) relative to the machine coordinate system 12. In addition, the workpiece 200 can be offset by an angle theta (θ) which can likewise be determined using photogrammetry.

FIG. 8 provides a schematic illustration of the various offsets that can be determined using photogrammetry, which illustratively include offsets along the x direction, y direction, z direction, and rotations about each axis. It is appreciated that offsets in the x, y, z directions and rotations about the x axis (θ) and about the y axis (β) can correspond to the five degrees of freedom illustrated in FIG. 1. As such, an original CAD data orientation can be translated to a new CAD data orientation as schematically illustrated in FIG. 9 and thus afford for the machining of complex and/or organic-shaped components. It is further appreciated that it can be extremely difficult to determine the position, location and/or orientation organic-shaped components using mechanical methods. For example, it is known to those skilled in the art that on the order of hundreds of points must be determined in order to determine the accurate position, location and/or orientation of an organic-shaped component relative to a machine coordinate system and as such can require excessive set-up time and/or labor. Stated differently, the use of heretofor methods can be impractical for determining the generally accurate position, location and/or orientation of an organic-shaped component relative to a machine coordinate system.

In summary, using photogrammetry the accurate placing of a workpiece relative to a machine coordinate system is no longer required and using tooling balls, holes in the workpiece, edges and the like in combination with portable coordinate measuring machines, tactile probes placed within a machine spindle, etc., is also no longer required. As such, subsequent setups of a workpiece can be placed on a machine in an imprecise manner and yet precisely located and machined with great accuracy. In addition, by eliminating the necessity of precisely positioning a workpiece before machining, it is possible to change a machining strategy from one that focuses on an ability to precisely locate a workpiece via fixtures, mechanical stops, or some other means to a strategy that focuses more on machinability, improved surface finish, improved accuracy, and/or reduced cycle time.

The process also provides for translating workpiece CAD data and any offset thereto to a machining system such that a computer numerical controlled (CNC) machine programmer can check for collisions of a machining tool with the machine and/or the workpiece at every setup. In addition, the process lends itself to machining operations where multiple setups are required for a single workpiece in order to complete the machining thereof.

The invention is not restricted to the illustrative embodiments or examples described above. The examples or embodiments are not intended as limitations on the scope of the invention. Processes, apparatus, designs, and the like described herein are exemplary and not intended as limitations on the scope of the invention. Changes therein and other uses will occur to those skilled in the art. The scope of the invention is defined by the scope of the claims.

We claim:

1. A process for accurately determining a workpiece position, location and/or orientation in relation to a machine coordinate system, the process comprising:
providing a machine having a table and a machine coordinate system;
determining locations of three reference geometrical aspects of the table;
providing a workpiece;
attaching the workpiece to the table;
determining locations of three reference geometrical aspects of the workpiece using photogrammetry;
determining an offset between the three reference geometrical aspects of the table and the three geometrical aspects of the workpiece; and
using the offset to accurately determine the workpiece position in relation to the machine coordinate system.

2. The process of claim 1, wherein the three reference geometrical aspects of the table are selected from the group consisting of three points, one plane and two axes, and one plane and one axis and one point.

3. The process of claim 1, wherein the three reference geometrical aspects of the workpiece are three contrast targets attached to the workpiece.

4. The process of claim 1, further comprising the machine having a tool with a tool path, the tool path referenced to the machine coordinate system.

5. The process of claim 4, wherein the tool path is adjusted by the offset between the three reference geometrical aspects of the table and the three geometrical aspects of the workpiece.

6. The process of claim 5, wherein the tool is a machining tool.

7. The process of claim 6, further comprising machining a first portion of the workpiece using the machining tool following at least one of the tool path referenced to the machine coordinate system and the adjusted tool path.

8. The process of claim 7, further comprising:
unattaching the workpiece from the table after the first portion has been machined;
rotating the workpiece into a different position;
reattaching the workpiece in the different position to the table;
determining another offset between the three reference geometrical aspects of the table and three geometrical aspects of the workpiece;
using the another offset to accurately determine the rotated workpiece position in relation to the machine coordinate system;
adjusting the tool path by the another offset; and
machining a second portion of the workpiece using the tool path adjusted by the another offset.

9. The process of claim 8, wherein machining the first portion and the second portion of the workpiece provides a finished component.

10. The process of claim 9, wherein the finished component is an organic-shaped component.

11. A process for machining a workpiece comprising:
providing a machine having a table, a tool and a machine coordinate system, the machine operable to move the tool along a first tool path, the first tool path referenced to the machine coordinate system;
determining at least three reference locations on the table, each of the three reference locations being at a known location in reference to the machine coordinate system;
providing a workpiece;
providing CAD data on the workpiece to the machine;
attaching the workpiece to the table;
determining at least three reference locations on the workpiece attached to the table using photogrammetry;
determining an offset between the at least three reference locations of the workpiece and the at least three reference locations on the table;
adjusting the first tool path by the offset in order to provide a second tool path; and
machining a first portion of the workpiece using the tool moving along the second tool path.

12. The process of claim 11, wherein the at least three reference locations on the table are selected from the group consisting of at least three points, at least one plane and at least two axes, and at least one plane and at least one axis and at least one point.

13. The process of claim 11, wherein the at least three reference locations on the workpiece are at least three contrast targets attached to the workpiece.

14. The process of claim 11, further comprising:
unattaching the workpiece from the table after the first portion has been machined;
rotating the workpiece into a different position;
reattaching the workpiece in the different position to the table;
determining another offset between the at least three reference locations on the table and at least three reference locations of the workpiece;
using the another offset to accurately determine the rotated workpiece position in relation to the machine coordinate system;
adjusting a tool path for machining a second portion of the workpiece by the another offset to provide a third tool path; and
machining a second portion of the workpiece using the third tool path.

15. The process of claim 14, wherein machining the first portion and the second portion of the workpiece provides a finished component.

16. The process of claim 15, wherein the finished component is an organic-shaped component.
